(19) United States
(12) Patent Application Publication
(10) Pub. No.: US 2022/0027858 A1
(43) Pub. Date: Jan. 27, 2022

(54) CUSTOMIZED SCHEDULES USING REAL-TIME USER PROVIDED DATA

(71) Applicant: International Business Machines Corporation, Armonk, NY (US)

(72) Inventors: Kala Krassimirova Nenkova, Georgetown, TX (US); Corinne Anne Leopold, Austin, TX (US); Anindita Das, Austin, TX (US); Timothy Echtenkamp, Leander, TX (US)

(21) Appl. No.: 16/935,888

(22) Filed: Jul. 22, 2020

(51) Int. Cl. G06Q 10/10; G06Q 50/00; G06Q 50/14; G06Q 30/02; G06N 20/00; G06N 5/04

(52) U.S. Cl. CPC G06Q 10/1093; G06Q 50/01; G06Q 50/14; G06Q 10/20; G06N 20/00; G06N 5/04; G06Q 30/0282

(57) ABSTRACT

One or more processors may receive user specific data and location data. A recommendation machine learning algorithm may be utilized by the one or more processors to analyze the user specific data and location data. A visit recommendation may be generated by the one or more processors using the recommendation machine learning algorithm, where the visit recommendation comprises one or more recommended locations. The one or more recommended locations of the visit recommendation may be arranged, by the one or more processors utilizing a scheduling algorithm, into a visit schedule. The visit recommendation or visit schedule may be revised, by the one or more processors, using real-time user data. An optimized visit schedule to a user may be output, by the one or more processors to a graphical user interface on a user device.

### BACKGROUND

The present disclosure relates generally to the field of providing customized schedules, and more specifically to providing customized schedules using real-time data from one or more users.

Many people visit locations such as theme parks, festivals, conferences, or other large events where there are multiple items, events, or attractions that can be attended. Scheduling an itinerary for these visits can be challenging as individuals may have multiple preferences about the visit, there may be much information about the locations and items, events, or attractions that may be considered in creating an itinerary, and the situation at these locations may change in real-time, creating logistical issues.

### SUMMARY

Embodiments of the present disclosure include a method, computer program product, and system for providing dynamic, customized schedules.

In some embodiments, one or more processors may receive user specific data and location data. In some embodiments, a recommendation machine learning algorithm may be utilized by the one or more processors to analyze the user specific data and location data. In some embodiments, a visit recommendation may be generated, by the one or more processors, using the recommendation machine learning algorithm, where the visit recommendation comprises one or more recommended locations. In some embodiments, the one or more recommended locations of the visit recommendation may be arranged, by the one or more processors, utilizing a scheduling algorithm into a visit schedule. In some embodiments, the visit recommendation or visit schedule may be revised, by the one or more processors, using real-time user data. In some embodiments, an optimized visit schedule may be outputted, by the one or more processors to a graphical user interface on a user device.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of an exemplary system for providing dynamic, customized schedules, in accordance with aspects of the present disclosure.

FIG. 2 is a flowchart of an exemplary method for providing dynamic, customized schedules, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of providing customized schedules, and more specifically to providing customized schedules using real-time data from one or more users. While the present disclosure is not necessarily limited to such applications, various aspects of the disclosure may be appreciated through a discussion of various examples using this context.

Many people visit locations such as theme parks, festivals, conferences, or other large events where there are multiple items, events, or attractions that can be attended. Scheduling an itinerary for these visits can be challenging as individuals may have multiple preferences about the visit; there may be much information about the locations and items, events, or attractions that may be considered in creating an itinerary; and the situation at these locations may change in real-time, creating logistical issues. The present disclosure is directed to customized schedules for people who visit such locations, as well as for people who work at the locations. The customizable schedules continuously integrate data from visitors and staff (e.g., users) to improve the itinerary recommendations provided to visitors and staff. The system uses data points from visitors and staff members to provide real-time, personalized recommendations for visitors as they navigate the theme park, festival, or conference, while at the same time providing real-time recommendations for staff members to improve operational efficiency.

In some embodiments, one or more processors may receive user specific data and location data. In some embodiments, the user specific data may include data about the user and the user's preferences regarding the location. In some embodiments, the location data may include current and historical data about the location. As an example, the location data may be data about a theme park, and the user specific data may be data about a visitor to the theme park and her preferences for her visit.

Furthering this example, the user specific data may include the user's metrics, the number of people in the visitor's party (and information about the metrics of the members in the party), the number of children in the party, the intensity of ride preferred (e.g., a numerical score representing how intense the physical forces are during a ride), the estimated length of the park visit, any budget restrictions (e.g., willingness to pay additional fees associated with a particular show or attraction), food preferences (e.g., preferences for a particular type of food or food that is suitable for people with particular dietary restrictions), interests in specific shows or types of shows, interest in specific rides or types of rides, or other customization preferences (e.g., no water rides in the last one hour of the visit or a food break after every two rides).

The user specific data may also include geospatial information such as the current location of the user. In some embodiments, the user may provide user specific data to the processors only after the user provides consent for user specific data to be used. In some embodiments, the user may also indicate how much data is to be shared with the processors.

Furthering this example, the location data may include historical data or current data about the theme park. For example, location data may include data about attractions at the location (e.g., rides and shows of the theme park), including, a list of available rides, ride locations, real-time attraction status (e.g., is the ride or show open, closed, only operating at half capacity, under maintenance, closed for a short while), attraction popularity scores, real-time length of all lines (for rides, shows, etc.), estimated wait times in real-time, historical wait times for attractions, variations in historical wait times for attractions based on various factors (e.g., historically wait times for shows are greater (and by how much) in the afternoons immediately after lunch, historical wait times for water rides are greater (and by how much) on days above 90 degrees that are not cloudy, historical wait times for one specific ride increase two-fold if another specific ride is closed for maintenance), ride intensity, physical restrictions for the attractions, and a list of popular attractions as rated by guests.

In some embodiments, location data may also include data about food or other facilities at the location. For example, the location data may include a list of available food provider, locations of food providers, ratings for the food providers (internally collected or from external websites), types of food available from the food providers, real-time lengths of food lines, and estimated wait times for food. The location data may also include lists, locations, and descriptions of other facilities such as the lost and found, park security, information centers, or specific types of stores (e.g., souvenir or customized goods). The location data may also include geospatial data such as ADA compliant routes between locations or future and real-time weather conditions.

In some embodiments, the one or more processors may utilize a recommendation machine learning algorithm to analyze the user specific data and location data. In some embodiments, the recommendation machine learning algorithm may be any machine learning algorithm capable of utilizing the user specific data, location data, real-time user data (described below), and changes to the user specific and location data to provide a recommendation score and ranking for each of one or more locations or items at the location (e.g., park attractions, rides, shows) for the user. In some embodiments, the machine learning algorithm may be a recurrent neural network (“RNN”).

In some embodiments, the one or more processors may generate a visit recommendation using the recommendation machine learning algorithm. In some embodiments, the visit recommendation may comprise one or more recommended locations. For example, the visit recommendations may be a list of theme park attractions, including theme park rides and theme park shows, which are recommended for the user based on the user specific data and location data provided.

In some embodiments, the one or more processors may arrange, utilizing a scheduling algorithm, the one or more recommended locations of the visit recommendation into a visit schedule. The scheduling algorithm may be any algorithm, including a machine learning algorithm, which is able to arrange, order, or group the one or more recommendations, based on parameters such as optimization of number of locations, minimization of wait times at locations, minimization of time in route to the locations, or minimization of crowding by multiple users at specific locations.

For example, the visit schedule may list the theme park attractions (e.g., theme park rides and theme park shows) in an order to be visited. As another example, the visit schedule may include groups of attractions to be visited at various times of the day. As another example, the visit schedule may include recommended time slots (e.g., from 2 pm to 4 pm) for visiting one or more attractions. In some embodiments, the visit schedule may include prompts to which the user may respond for providing more information to customize the visit schedule (e.g., a prompt inquiring about whether the user would prefer an earlier or later lunch break or whether it is preferable to go on a water ride towards the end of the park visit or towards the middle of the visit).

In some embodiments, the one or more processors may revise the visit recommendation or visit schedule using real-time user data. Real-time user data may include any data collected about the location, or about the user, and the user's preference for the location which provides information about current, real-time, or near-real-time occurrences. In some embodiments, the real-time user data may include updates to the user specific data or the location data. For example, the real-time user data may be real-time weather data indicating that there is currently a thunderstorm in the area of the theme park. As another example, the real-time data may be the real-time location of a user or real-time feedback provided by a user about the maintenance needs of a theme park attraction. Based on the real-time user data, the visit recommendation may be revised (e.g., based on maintenance data indicating that the newest high intensity rollercoaster at the park has to be closed for the afternoon, a visit recommendation including the newest high intensity rollercoaster among other attractions to be visited may be revised to include another high intensity rollercoaster instead).

In some embodiments, based on the real-time user data, the visit schedule may be revised to alter the order or timing of a user's visit to specific locations or types of locations (e.g., based on real-time weather data indicating that a thunderstorm will affect the area of the park for one hour, the visit schedule may be revised to switch the recommended order of the locations and attractions on the visit schedule so that an indoor show is scheduled for the time of the thunderstorm, rather than a large rollercoaster).

In some embodiments, the one or more processors may output, to a graphical user interface on a user device, an optimized visit schedule. The optimized visit schedule may be the visit schedule which has been revised based on the real-time user data available. The visit schedule may be revised to generate the optimized visit schedule at varying schedules, including: continuously, at set or variable intervals of time, after a location having one or more items and the one or more items has been visited by the user, after a group of attractions (e.g., the group of attractions listed on a visit schedule for a particular time range) has been visited, after one or more attractions have been visited, after a threshold amount of time has passed where the user is not moving, after a threshold amount of time has passed during the user is moving in particular locations (e.g., moving in an area where there are no attractions), after real-time user data which relates to an attraction on the visit schedule which exceeds a threshold is obtained by the system (e.g., real-time user data indicating that a particular ride is closed or real-time user data from a threshold number of users indicating that there is an issue affecting the performance or wait time for a particular attraction). In some embodiments, the visit schedule may be revised when a user opts to revise the visit schedule by, for example, selecting a refresh option on the graphical user interface.

The graphical user interface may display details about the one or more recommended locations which may inform the user about whether the user would like to visit the locations. These details may include wait times at theme park attractions, recommendations or requirements regarding who the attractions are suitable for (e.g., age and height requirements for amusement park rides), reviews of the attractions gathered from historical data from other users (e.g., through a feedback collection system run internally or from external sources such as websites), the location of the attraction (e.g., how far the visitor must walk to get to the attraction), or other information useful to users. The graphical user interface may provide guidance on the best way (e.g., fastest route, shaded route, or ADA accessible route) to get to the location.

For example, a suggested route and alternative suggested routes may be mapped out on a map feature displayed on the graphical user interface. The graphical user interface may also provide an option to filter or sort the recommended attractions based on any of the additional details provided about the attractions. The graphical user interface may additionally include an option to select which of the locations of the one or more recommended locations to visit, an option to refresh the locations, and an option to refresh the order that they are recommended to be visited. The refresh option may allow the visit recommendation or visit schedule to be revised using the real-time user data and/or the selection made by the user.

In some embodiments, the user specific data may include data gathered from one or more social media accounts associated with the user. Social media accounts may include methods of sharing information by the Internet with one or more other users via social media platforms. Social media data may be gathered from posts on social media platforms, comments or responses (such as likes) to posts on social media, or other means of conveying information on social media such as interests expressed, direct messages, inquiries made, answers provided, videos or links posted, individuals or groups followed, etc.

For example, a picture of someone skydiving shared on social media may indicate that the user has a preference for rides of higher ride intensity or may enjoy rides where a rider experiences free fall or lengthy downhill drops on a roller coaster. As another example, the user may have indicated an interest in a particular movie and based on data indicating an interest in the movie, the user may be directed towards a show or a themed ride based on the characters of the movie. In some embodiments, the user may opt-in to providing the system access to social media accounts. For example, a prompt may appear on the graphical user interface asking the user whether the user agrees to provide the system with social media account access and the user may select a response (e.g., yes, no, more information).

In some embodiments, the user specific data may include data provided by the user, where the user inputs the user specific data via the graphical user interface. For example, some user specific data may be obtained after a prompt on the graphical user interface requests information from the user about the user's physical characteristics. The user specific data input by the user may also include user preferences for how to arrange the number and variety of attractions that the user would like to visit (e.g., a desire to visit all the large rollercoasters or the frequency of breaks for food needed).

In some embodiments, the real-time user data may include motion profile data, where the motion profile data is motion data associated with a specific item within the one or more recommended locations, and where the motion profile data is utilized to update the optimized visit schedule. In some embodiments, the motion profile data is collected by sensors on or in proximity to the user. For example, the motion profile data may be collected by sensors on a user's smartphone or smartwatch, such as GPS, gyroscopes, rotations sensors, accelerometers.

In some embodiments, the motion profile data is collected by one or more processors on the user's phone and compared to motion profile data stored in a database which is associated with a particular item at a location (e.g., a particular ride at a theme park) within the visit schedule. For example, the motion profile data collected for a user may be motion data indicating that the user went on a roller coaster with a 200 foot initial hill, three consecutive loops, and a spiral portion. That motion data may be compared to motion profile data for each rollercoaster in the park which provides information about the motion that someone on the ride would experience (e.g., number of loops, number of hills, length of ride, initial hill height, height for all hills, length of each loop, g-forces on each loop, duration of ride, rollercoaster speed in any portion of the ride, or the length, speed, acceleration, duration, g-forces experienced in any spiral or twisted portions of the rollercoaster, etc.).

Based on the comparison, the motion profile data may be used to determine which ride the user is currently, or was previously, on. Motion profile data indicating which ride the user is currently, or was previously, on may be used to update the optimized visit schedule. For example, that a user visited two or more high intensity rides at a theme park may provide an indication that the user prefers high intensity rides, and an optimized visit schedule may be provided to the user that includes all the high intensity rides at the park. In some embodiments, the motion profile data of a user may be used to determine location recommendations when the user has opted to not provide user specific data. In some embodiments, the user may grant permission for the system to use motion profile data to provide the user with a customized visit itinerary by providing location recommendations or an optimized visit schedule.

In some embodiments, the real-time user data may include feedback data provided by the user, where the feedback data is utilized to update the optimized visit schedule. For example, after motion profile data is collected for a user to identify the ride that the user has just taken, the user may be prompted to provide feedback about whether the user enjoyed the ride. Data about how the user enjoyed the ride may be used to revise the visit recommendation using the recommendation machine learning algorithm (e.g., to include more rides that are similar if the user enjoyed the ride) or revise the visit schedule using the scheduling algorithm (e.g., to rearrange the order of the rides so that the next rollercoaster is not immediately after the ride that the user provided feedback on, if, for example, the user indicated that the previous ride was enjoyable but had too many loops).

The feedback data may also include other information about the suitability of the ride for others or if there were any issues with the ride that staff at the theme park or operational users (described below) should know about. For example, the user may be prompted to provide information about the suitability of the ride for children of various ages. As another example, the user may be prompted to provide feedback about ride maintenance issues, which affected line length and enjoyment of the ride (e.g., four of the ten seats on the ride have restraints which are stuck in the closed position and are not in use increasing ride wait times or one fan which cools people waiting in line for a ride is not operational), or provide feedback about whether predicted wait times for the attraction were accurate.

In some embodiments, the real-time user data may include geospatial data, where the geospatial data is incorporated by the recommendation machine learning algorithm to identify recommended locations that can predictively be visited by the user. In some embodiments, the geospatial data may include real-time location data about the user. For example, if immediately after the user went on a pendulum type-ride, the user provided feedback that the user enjoyed the ride very much, another pendulum type ride may be recommended to the user based on the current, real-time, or near real-time location of the user close to the other pendulum type ride.

In some embodiments, the optimized visit schedule provided to the visitor may include a missed recommended item feature, where the missed recommended item feature provides an indication to the visitor that a recommended item at a location on the optimized visit schedule may be missed. The missed recommended item feature may track the location or the movement of the user and determine if the location and movement of the user indicate that the user may miss the item (e.g., a Ferris wheel).

In another embodiment, the missed recommended item feature may identify certain movements or locations as indicating a likelihood of the user to miss an attraction. For example, during a time period when the next attraction on the user's optimized visit schedule is the Ferris wheel, the feature may identify when the user leaves an area surrounding the Ferris wheel, when the user goes on a path that differs from the path necessary to go to the Ferris wheel, or when a user walks around the periphery of an area surrounding the Ferris wheel but does not go nearer to the Ferris wheel, as indicating a likelihood of the user to miss the Ferris wheel attraction.

In some embodiments, if the location, movement, or lack of movement of the user exceeds a threshold, the user may receive a notification regrading potentially missing the next recommended item. The notification may inform the user that she may miss the next recommended item and also provide other prompts regarding missing the next recommended item (e.g., prompts asking if the user wants to go to the Ferris wheel, would prefer to go to the Ferris wheel later, would like to push the Ferris wheel to the end of the visit schedule, or would like to be directed somewhere else instead (e.g., restroom, food, quiet place to relax), etc.).

In some embodiments, the missed recommended item feature may assist the user to go to the next recommended item or to another place instead. For example, directions and/or a map showing the locations of the Ferris wheel or other places (food, quiet place to sunbathe, etc.), and routes to them, may be provided to the user on a graphical user interface of the user's mobile phone. In some embodiments, the graphical user interface may also provide a visit map showing locations of past and future locations on the optimized visit schedule. The visit map may also show the next attraction on the optimized visit schedule, which is to be visited, attractions declined to be visited by the user, or attractions that are currently closed or have wait times that exceed a threshold (e.g., because of maintenance issues).

In some embodiments, the method for providing dynamic, customized schedules may further comprise utilizing, by the one or more processors, an operating machine learning algorithm, where the operating machine learning algorithm analyzes operating data to generate an operating schedule for one or more operating users. In some embodiments, the operating data may be historical or current data (e.g., as provided by real-time user data, for example, ride X is jammed) about the location which may be useful to managing daily functioning of the location. For example, for a theme park, operating data may include data about attractions at the theme park, data about personnel of the theme park, maintenance data, other types of data about the running of the theme park. In another example, data about attractions at the theme park may include estimated times to set up the park every day (e.g., individual preparation times needed for rides, food stands, shows, and other attractions, or the total time required for all staff to be ready for visitors), ride and show duration, real-time maintenance status of every ride, and ride popularity scores.

In some embodiments, data about personnel may include data about staff vacations schedules, the role of each staff member, work shifts, real-time availability of staff members, etc. In some embodiments, maintenance data may include data about the historical duration for a particular maintenance task at a particular maintenance location, the frequency of the maintenance task at a particular maintenance location, real-time maintenance needs, or other relevant information about maintaining the operability of any location, item, or attraction of the park. Other types of data about the running of the theme park may include real-time number of visitors, historical numbers of visitors under varying conditions (e.g., times of day, days of week, weather, holidays, etc.), historical ride maintenance data (e.g., which rides frequently require replacement parts or require maintenance checks), user feedback or online reviews, real-time personnel need statistics (e.g., real-time data on the location where personnel are needed or not needed within the park, locations of crowds, etc.), and historical personnel need statistics (e.g., locations where staff members have been needed the most or least).

In some embodiments, the operating machine learning algorithm may be any machine learning algorithm capable of utilizing the operating data to provide one or more operating schedules to one or more operating users. In some embodiments, the operating schedule for one or more operating users may be a list of jobs or tasks at particular locations or items (e.g., attractions, shows, rides) arranged in an order or corresponding to a time slot which is individualized to each of the one or more operating users. In some embodiments, the operating schedule for a particular operating user may include lists of jobs or tasks at particular locations or items (e.g., attractions, shows, rides) arranged in an order, or corresponding to a time slot, for multiple people (e.g., if the operating user is a supervisor of the multiple people and communicates work schedules and details to each of the multiple people).

In some embodiments, the operating schedule informs the operating user about what the operating user's job task will be, for what times, and provides additional details about the job task, such as other colleagues who will be part of the operating user's team, who the operating user reports to, who report to the operating user, prior and future individuals assigned to a particular job task at a particular location, where resources needed to perform the job task are kept (e.g., location of maintenance equipment), etc.

In some embodiments, the method for providing dynamic, customized schedules further comprises utilizing, a future operating machine learning algorithm, where the future operating machine learning algorithm analyzes the operating data to make a future operation recommendation. In some embodiments, the future operating machine learning algorithm may be any machine learning algorithm capable of utilizing the operating data to provide future operation recommendations. In some embodiments, the future operation recommendation may include suggested ways to utilize operating user resources at particular locations or items (e.g., attractions, parks, rides). For example, future operation recommendations may include a list of recommendations for ways to optimize staff locations and scheduling in the future. For example, one recommendation may be to double the number of staff assigned to food vendors from 11 am until 2 pm, or to schedule maintenance of the newest highest intensity rollercoasters from 11 am until 2 pm based on patterns that the future operating machine learning algorithm may detect.

In some embodiments, the method for providing dynamic, customized schedules further comprises revising the operating schedule for each of the one or more operating users using real-time operating data. In some embodiments, the real-time operating data may include any changes to the operating data based on current, real-time, or near real-time information. The real-time data may be collected by operating users and include real-time maintenance status of every ride, real-time availability of staff, real-time maintenance needs, real-time data on the location where personnel are needed or not needed within the park, real-time number of visitors. In some embodiments, the method for providing dynamic, customized schedules further comprises providing a real-time map of specific locations in need of operating users to the one or more operating users.

In some embodiments, the real-time operating data may include data provided by operating user input. For example, the real-time operating data may be entered into a computing device by an operating user, e.g., an operating user may identify that maintenance is required at a particular location and may input that information into the computing device.

In some embodiments, the real-time operating data may include data based on the real-time user data. In some embodiments, real-time user data, such as information about wait times, maintenance issues, or real-time location data of users, may be used to revise the operating schedule for one or more operating users using real-time operating data. For example, real-time location data from users may indicate that more park visitors are currently at a few rides and more staff members may be reassigned to those rides.

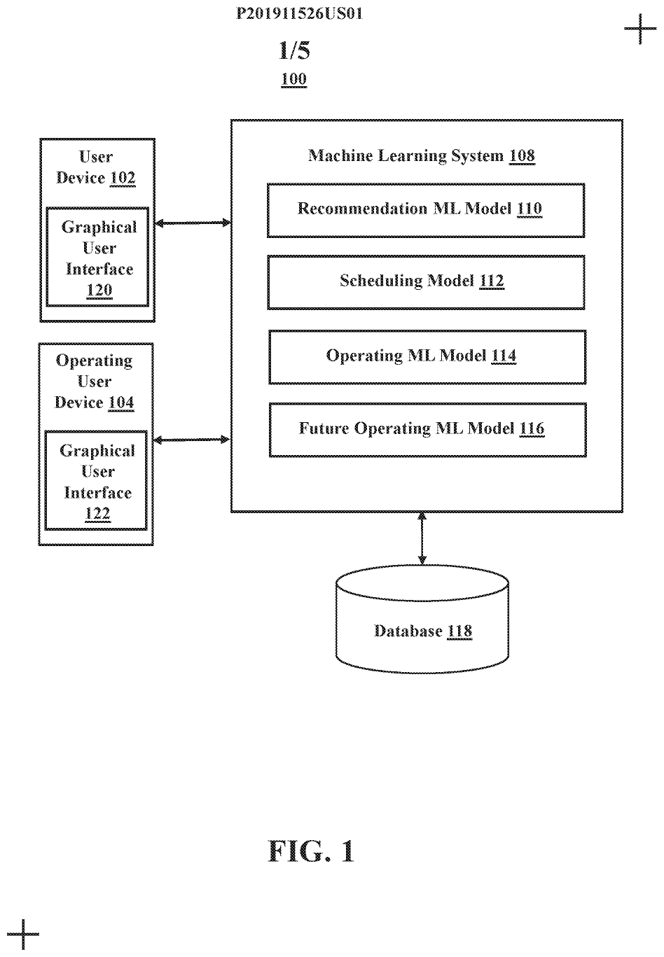

Referring now to FIG. 1, a block diagram of a network 100 for providing dynamic customized schedules is illustrated. Network 100 includes a user device 102 and an operating user device 104 that are configured to be in communication with machine learning system 108. In some embodiments, user device 102 and operating user device 104 may be any device that contains a processor configured to perform one or more of the functions or steps described herein this disclosure. User device 102 and operating user device 104 may be mobile computing devices such as cell phones, tablets, laptops, or smartwatches.

Network 100 includes a machine learning system 108 that includes a recommendation machine learning model 110, a scheduling model 112, an operating machine learning model 114, and a future operating machine learning model 116. In some embodiments, the machine learning system 108 is in communication with database 118 in which the data used by the models 110-116, including user specific data, location data, real-time user data, motion profile data, operating data, real-time operating data, and geospatial data, is stored.

As data is obtained from one or more users and one or more operating users, in some embodiments, via the user device 102 and/or the operating user device 104, that data is stored in the database 118 along with other data already in the database 118, such as historical location data. The location data and user specific data is utilized by the recommendation machine learning model 110 utilizing the recommendation machine learning algorithm to generate a visit recommendation. The scheduling model 112 utilizes the scheduling algorithm to arrange the one or more recommended locations of the visit recommendation into a visit schedule. As the data changes the visit recommendation and visit schedule are revised by the recommendation machine learning model 110 and the scheduling model 112.

An optimized visit schedule is output to a user device 102 and displayed on a graphical user interface 120, on which the user may also provide consent to share data with system 100, input data, provide feedback, see a optimized visit schedule, see a map, and utilize the missed recommended item feature. The operating data is utilized by the operating machine learning model 114 utilizing the operating machine learning algorithm to generate an operating schedule for one or more operating users. The operating data is also utilized by the future operating machine learning model 116 utilizing the future operating machine learning algorithm to make a future operation recommendation. The operating schedule for each of the one or more operating users is revised using the operating machine learning model using real-time operating data. A real-time map of specific location in need of operating users is provided to each operating user on a graphical user interface 122 of an operating user device 104.

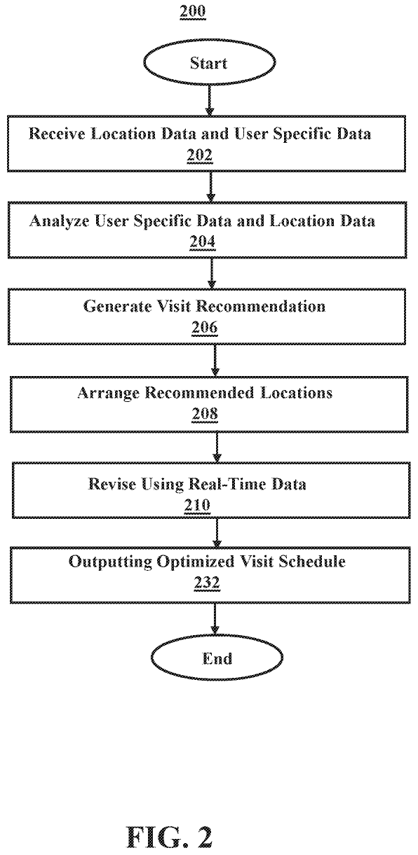

Referring now to FIG. 2, illustrated is a flowchart of an exemplary method 200 for providing dynamic, customized schedules, in accordance with embodiments of the present disclosure. In some embodiments, one or more processors of a system (e.g., a machine learning system) may perform the operations of the method 200. In some embodiments, method 200 begins at operation 202. At operation 202, the one or more processors receive user specific data and location data. In some embodiments, method 200 proceeds to operation 204, where the one or more processors utilize a recommendation machine learning algorithm to analyze the user specific data and location data.

In some embodiments, method 200 proceeds to operation 206. At operation 206, a visit recommendation is generated by the one or more processors using the recommendation machine learning algorithm. In some embodiments, the visit recommendation comprises one or more recommended locations. In some embodiments, method 200 proceeds to operation 208. At operation 208, the one or more recommended locations of the visit recommendation are arranged, by the one or more processors utilizing a scheduling algorithm, into a visit schedule. In some embodiments, method 200 proceeds to operation 210. At operation 210, the visit recommendation or visit schedule are revised, by the one or more processors, using real-time user data. In some embodiments, method 200 proceeds to operation 212. At operation 212, an optimized visit schedule is output by the one or more processors to a graphical user interface on a user device.

As discussed in more detail herein, it is contemplated that some or all of the operations of the method 200 may be performed in alternative orders or may not be performed at all; furthermore, multiple operations may occur at the same time or as an internal part of a larger process.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

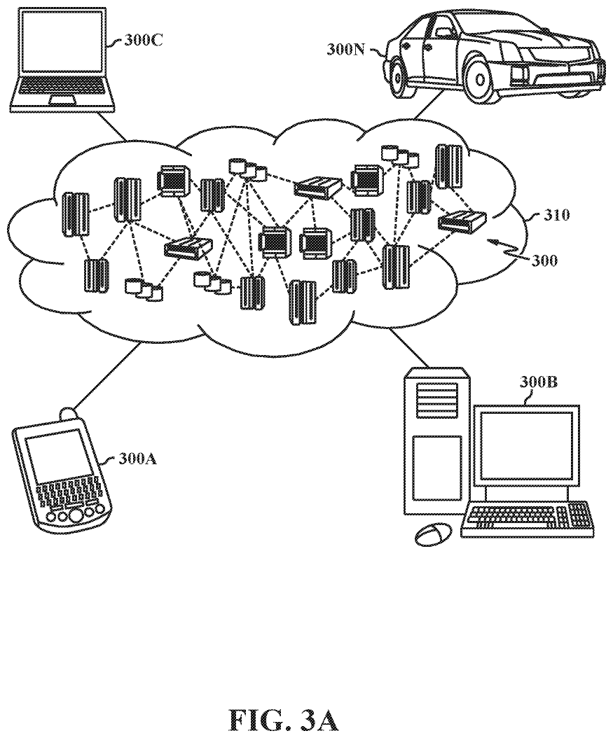

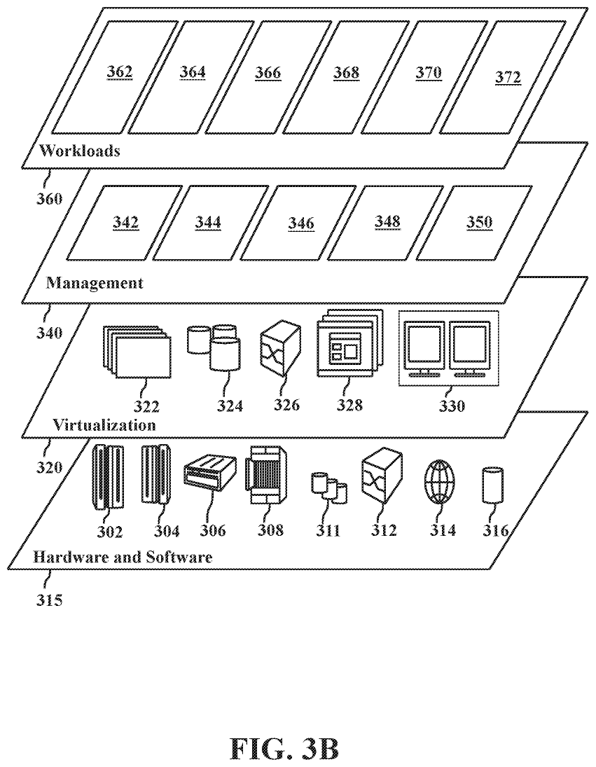

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and providing dynamic, customized schedules 372.

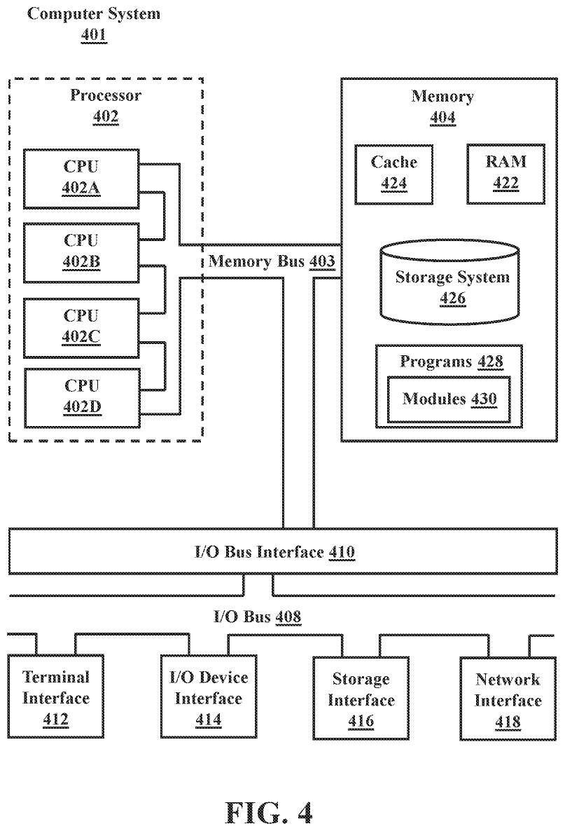

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method for providing dynamic, customized schedules, the method comprising:
receiving, by one or more processors, user specific data and location data;
utilizing, by the one or more processors, a recommendation machine learning algorithm to analyze the user specific data and location data;
generating, by the one or more processors, a visit recommendation using the recommendation machine learning algorithm, wherein the visit recommendation comprises one or more recommended locations;
arranging, by the one or more processors, utilizing a scheduling algorithm, the one or more recommended locations of the visit recommendation into a visit schedule;
revising, by the one or more processors, the visit recommendation or visit schedule using real-time user data; and
outputting, by the one or more processors to a graphical user interface on a user device, an optimized visit schedule.

2. The method of claim 1, wherein the user specific data includes data gathered from one or more social media accounts associated with the user.

3. The method of claim 1, wherein the user specific data includes data provided by the user, wherein the user input the user specific data via the graphical user interface.

4. The method of claim 1, wherein the real-time user data includes motion profile data, wherein the motion profile data is motion data associated with a specific item within the one or more recommended locations, and wherein the motion profile data is utilized to update the optimized visit schedule.

5. The method of claim 1, wherein the real-time user data includes feedback data provided by the user, and wherein the feedback data is utilized to update the optimized visit schedule.

6. The method of claim 1, wherein the real-time user data includes geospatial data, wherein the geospatial data is incorporated by the recommendation machine learning algorithm to identify recommended locations that can predictively be visited by the user.

7. The method of claim 1, wherein the optimized visit schedule provided to the visitor includes a missed recommended item feature, wherein the missed recommended item feature provides an indication to the visitor that a recommended item may be missed.

8. The method of claim 1, further comprising:
utilizing, by the one or more processors, an operating machine learning algorithm, wherein the operating machine learning algorithm analyzes operating data to generate an operating schedule for one or more operating users;
utilizing, by the one or more processors, a future operating machine learning algorithm, wherein the future operating machine learning algorithm analyzes the operating data to make a future operation recommendation;
revising, by the one or more processors, the operating schedule for each of the one or more operating users using real-time operating data; and
outputting, by the one or more processors, a real-time map of specific locations in need of operating users.

9. The method of claim 8, wherein the real-time operating data includes data provided by operating user input.

10. The method of claim 8, wherein the real-time operating data includes data based on the real-time user data.

11. A system comprising:
a memory; and
a processor in communication with the memory, the processor being configured to perform operations comprising:
receiving user specific data and location data;
utilizing a recommendation machine learning algorithm to analyze the user specific data and location data;
generating a visit recommendation using the recommendation machine learning algorithm, wherein the visit recommendation comprises one or more recommended locations;
arranging, utilizing a scheduling algorithm, the one or more recommended locations of the visit recommendation into a visit schedule;
revising the visit recommendation or visit schedule using real-time user data; and
outputting, to a graphical user interface on a user device, an optimized visit schedule.

12. The system of claim 11, wherein the user specific data includes data gathered from one or more social media accounts associated with the user.

13. The system of claim 11, wherein user specific data includes data provided by the user, wherein the user input the user specific data via the graphical user interface.

14. The system of claim 11, wherein the real-time user data includes motion profile data, wherein the motion profile data is motion data associated with a specific item within the one or more recommended locations, and wherein the motion profile data is utilized to update the optimized visit schedule.

15. The system of claim 11, wherein the real-time user data includes feedback data provided by the user, and wherein the feedback data is utilized to update the optimized visit schedule.

16. The system of claim 11, wherein the real-time user data includes geospatial data, wherein the geospatial data is incorporated by the recommendation machine learning algorithm to identify recommended locations that can predictively be visited by the user.

17. The system of claim 11, wherein the optimized visit schedule provided to the visitor includes a missed recommended item feature, wherein the missed recommended item feature provides an indication to the visitor that a recommended item may be missed.

18. The system of claim 11, wherein the processor is further configured to perform operations comprising:
utilizing an operating machine learning algorithm, wherein the operating machine learning algorithm analyzes operating data to generate an operating schedule for one or more operating users;
utilizing a future operating machine learning algorithm, wherein the future operating machine learning algorithm analyzes the operating data to make a future operation recommendation;
revising the operating schedule for each of the one or more operating users using real-time operating data; and
providing a real-time map of specific locations in need of operating users.

19. The system of claim 18, wherein the real-time operating data includes data provided by operating user input and data based on the real-time user data.

20. A computer program product comprising a computer readable storage medium having program instructions embodied therewith, the program instructions executable by a processor to cause the processor to perform operations, the operations comprising:
receiving user specific data and location data;
utilizing a recommendation machine learning algorithm to analyze the user specific data and location data;
generating a visit recommendation using the recommendation machine learning algorithm, wherein the visit recommendation comprises one or more recommended locations;
arranging, utilizing a scheduling algorithm, the one or more recommended locations of the visit recommendation into a visit schedule;
revising the visit recommendation or visit schedule using real-time user data; and
outputting, to a graphical user interface on a user device, an optimized visit schedule.
